(19) United States
(12) Patent Application Publication
(10) Pub. No.: US 2026/0008928 A1
(43) Pub. Date: Jan. 8, 2026

(54) INK-JET INK OPTIMIZED IN TERMS OF COMPOSITION OF SPECIFIC RESIN AND PARTICLE DIAMETER AND NUMBER CONCENTRATION OF COARSE PARTICLES

(71) Applicant: KYOCERA Document Solutions Inc., Osaka (JP)

(72) Inventors: Ryota KOBAYASHI, Osaka (JP); Seishi OJIMA, Osaka (JP); Tomoaki AONO, Osaka (JP)

(73) Assignee: KYOCERA Document Solutions Inc., Osaka (JP)

(21) Appl. No.: 19/249,591

(22) Filed: Jun. 25, 2025

(30) Foreign Application Priority Data
Jul. 5, 2024 (JP) 2024-109024

(51) Int. Cl. C09D 11/322

(52) U.S. Cl. CPC C09D 11/322

(57) ABSTRACT

An ink-jet ink contains an aqueous vehicle and pigment particles dispersed in the aqueous vehicle. The specific resin is a neutralized product of a copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate. Respective contents of the first, second, third, and fourth repeating units in the specific resin are, relative to 100% by mass of all the repeating units, 1% to 65% by mass, both inclusive, 1% to 60% by mass, both inclusive, 10% to 40% by mass, both inclusive, and 1% to 12% by mass, both inclusive, respectively. A number concentration of coarse particles having a diameter of not less than 0.5 μm and not more than 1.0 μm in the ink-jet ink is not more than 1500×10⁵/mL.

### INCORPORATION BY REFERENCE

This application claims priority to Japanese Patent Application No. 2024-109024 filed on 5 Jul. 2024, the entire contents of which are incorporated by reference herein.

### BACKGROUND

The present disclosure relates to ink-jet inks.

There is known a water-based ink for ink-jet recording that has excellent scratch resistance when printed on exclusive papers and takes on high print darkness when printed on plain papers. A known example of this type of ink-jet ink is a water-based ink for ink-jet recording which contains 4.5% by weight or more yellow pigment and in which the number of yellow pigment dispersions having a particle diameter of 0.57 μm or more is not more than 1.2×10⁷/mL.

Another known example is a water-based ink for ink-jet recording which contains 3.0% by weight or more magenta pigment or cyan pigment and in which the number of magenta pigment dispersions or cyan pigment dispersions having a particle diameter of 0.57 μm or more is not more than 1.2×10⁷/mL.

### SUMMARY

A technique improved over the aforementioned techniques is proposed as one aspect of the present disclosure.

An ink-jet ink according to an aspect of the present disclosure contains an aqueous vehicle and pigment particles dispersed in the aqueous vehicle. The pigment particle contains a pigment and a specific resin. The specific resin is a neutralized product of a copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate. Respective contents of the first repeating unit, the second repeating unit, the third repeating unit, and the fourth repeating unit in the specific resin are, relative to 100% by mass of all the repeating units, not less than 1% by mass and not more than 65% by mass, not less than 1% by mass and not more than 60% by mass, not less than 10% by mass and not more than 40% by mass, and not less than 1% by mass and not more than 12% by mass, respectively. A number concentration of coarse particles having a diameter of not less than 0.5 μm and not more than 1.0 μm in the ink-jet ink is not more than 1500×10⁵/mL.

### DETAILED DESCRIPTION

### <Ink-Jet Ink>

A description will be given of an ink-jet ink (hereinafter, referred to simply as an “ink”) according to an embodiment of the present disclosure.

Herein, acrylic and methacrylic may be referred to collectively as “(meth)acrylic”. Herein, acrylate and methacrylate may be referred to collectively as “(meth)acrylate”.

The ink according to this embodiment contains an aqueous vehicle and pigment particles dispersed in the aqueous vehicle. The pigment particle contains a pigment and a specific resin.

The specific resin is a neutralized product of a copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate.

Respective contents of the first repeating unit, the second repeating unit, the third repeating unit, and the fourth repeating unit in the specific resin are, relative to 100% by mass of all the repeating units, not less than 1% by mass and not more than 65% by mass, not less than 1% by mass and not more than 60% by mass, not less than 10% by mass and not more than 40% by mass, and not less than 1% by mass and not more than 12% by mass, respectively.

The number concentration of coarse particles having a diameter of not less than 0.5 μm and not more than 1.0 μm in the ink according to this embodiment is not more than 1500×10⁵/mL. In this embodiment, the number concentration of coarse particles is a value measured with a coarse particle counter (“AccuSizer” manufactured by PSS (Particle Sizing Systems), LLC.).

Problems of image forming apparatuses capable of high-speed printing and printing a large number of sheets in total are increase in ink scattering due to the effect of wind and increase in the amount of in-apparatus contamination accumulated with increasing number of printed sheets. There is demand for development of less scattering ink compatible with the image forming apparatuses as just described.

However, although, in the general water-based ink for ink-jet recording described previously, consideration is given to a desirable surface tension, no consideration is given to the problem of in-apparatus contamination due to ink scattering. Therefore, the general water-based ink cannot solve the above problems.

Unlike the general water-based ink, since the ink according to this embodiment has the above-described structure and features, it enables the formation of an image having a desired image density while reducing the occurrence of nozzle clogging. In addition, in-apparatus contamination due to ink scattering for long-term duration can be reduced. The reasons why the ink according to this embodiment exerts these effects will be described below.

### (Optimization of Contents of First to Fourth Repeating Units)

Each of the first to fourth repeating units constituting the specific resin has the following functions. The first repeating units moderately increase the affinity between a cross-linked resin and the pigment particles. The second repeating units give the cross-linked resin moderate hydrophobicity to adjust the dispersion stability of the pigment particles. The third repeating units and the fourth repeating units give the cross-linked resin moderate hydrophilicity and give the pigment particles dispersion stability.

Generally, in order to reduce the occurrence of nozzle clogging, it is effective to give the pigment particles high dispersion stability. However, when an ink containing pigment particles having high dispersion stability is landed to a recording medium, the pigment particles penetrate deep into the recording medium together with the aqueous vehicle, which makes it likely that the image density of the formed image becomes low.

To cope with this, the present discloser found that when the respective contents of the first to fourth repeating units in the specific resin are within the above-described respective ranges, the dispersion stability of the pigment particles can be optimized and, thus, both the reduction in occurrence of nozzle clogging and the formation of images having good image density can be satisfied.

### (Optimization of Particle Diameter and Number Concentration of Coarse Particles)

Generally, in-apparatus contamination due to ink scattering becomes worse when each ink droplet ejected through nozzles does not remain a single droplet, but splits into subdroplets. The degree of this droplet splitting is known to be controllable by the viscosity and surface tension of the ink. The present discloser conducted intensive studies for controlling the degree of droplet splitting and, as a result, found that when an ink droplet being ejected through a nozzle contains coarse particles, droplet splitting starts from the coarse particles as origins.

Specifically, the present discloser found that the degree of droplet splitting is controllable not only by the viscosity and surface tension of the ink, but also the particle diameter and number concentration of coarse particles in the ink. Based on this finding, the present discloser further found that when the number concentration of coarse particles having a diameter of not less than 0.5 μm and not more than 1.0 μm in the ink according to this embodiment is optimized at not more than 1500×10⁵/mL, droplet splitting can be reduced without changing the composition of the ink.

The usage of the ink according to this embodiment is not particularly limited, but, for example, the ink can be used for image formation on permeable recording media or non-permeable recording media. The ink according to this embodiment is suitable for image formation on permeable recording media. The permeable recording media have excellent ink penetration. Examples of the permeable recording media include printing paper and media made from fibers, such as fabrics. Examples of printing paper include plain paper, copy paper, recycled paper, thin paper, paperboard, and glossy paper.

Hereinafter, a detailed description will be given of components of the ink according to this embodiment. Each of the components described below may be used as a single type of material or in combination of two or more types of materials.

### [Aqueous Vehicle]

The aqueous vehicle is a vehicle containing water. The aqueous vehicle may function as a solvent or a dispersion medium. A specific example of the aqueous vehicle is an aqueous vehicle containing water and a water-soluble organic solvent.

### (Water)

The content of water in the ink according to this embodiment is preferably not less than 25.0% by mass and not more than 80.0% by mass, and more preferably not less than 35.0% by mass and not more than 60.0% by mass.

### (Water-Soluble Organic Solvent)

Examples of the water-soluble organic solvent include a glycol compound, a triol compound, a glycol ether compound, a lactam compound, a nitrogen-containing compound, an acetate compound, thiodiglycol, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, tetraethylene glycol, and 2-ethyl-1,2-hexanediol. Among them, the preferred glycol compounds are ethylene glycol, diethylene glycol, 2-ethyl-1,2-hexanediol, 3-methyl-1,5-pentanediol, 1,3-propanediol, 1,5-pentanediol, and propylene glycol.

Examples of the triol compound include glycerin and 1,2,3-butanetriol.

Examples of the glycol ether compound include diethyl diglycol, diethylene glycol monobutyl ether, ethylene glycol monomethyl ether, ethylene glycol monobutyl ether, diethylene glycol monomethyl ether, diethylene glycol monoethyl ether, diethylene glycol diethyl ether (diethyl diglycol), triethylene glycol monomethyl ether, triethylene glycol monoethyl ether, triethylene glycol monobutyl ether, and propylene glycol monomethyl ether. Among them, the preferred glycol ether compound is triethylene glycol monobutyl ether.

Examples of the lactam compound include 2-pyrrolidone and N-methyl-2-pyrrolidone. Among them, the preferred lactam compound is 2-pyrrolidone.

Examples of the nitrogen-containing compound include 1,3-dimethyl imidazolidinone, formamide, and dimethyl formamide.

An example of the acetate compound is diethylene glycol monoethyl ether acetate.

The preferred water-soluble organic solvent is a glycol compound or a glycol ether compound, and the more preferred water-soluble organic solvent is ethylene glycol or diethyl glycol.

The content of water-soluble organic solvent in the ink according to this embodiment is preferably not less than 10.0% by mass and not more than 50.0% by mass, and more preferably not less than 30.0% by mass and not more than 40.0% by mass.

The content of glycol compound in the ink according to this embodiment is preferably not less than 5.0% by mass and not more than 45.0% by mass, and more preferably not less than 15.0% by mass and not more than 25.0% by mass.

The content of glycol ether compound in the ink according to this embodiment is preferably not less than 5.0% by mass and not more than 30.0% by mass, and more preferably not less than 10.0% by mass and not more than 20.0% by mass.

### [Pigment Particles]

As described previously, the pigment particle contains a pigment and a specific resin. The specific resin is preferably cross-linked by a cross-linking agent to form a cross-linked resin. In other words, the cross-linked resin is a cross-linked product of the specific resin and the cross-linking agent. The pigment particle is constituted, for example, by: a core containing a pigment; and a specific resin or a cross-linked resin that covers the core. The content of pigment and specific resin in the pigment particles or the content of pigment and cross-linked resin in the pigment particles is preferably not less than 90% by mass and more preferably 100% by mass.

From the viewpoint of optimizing the color density, hue or stability of the ink according to this embodiment, the volume median diameter of the pigment particles is preferably not less than 30 nm and not more than 200 nm, and more preferably not less than 80 nm and not more than 130 nm.

Herein, the measured value of the volume median diameter (D₅₀) refers to a value measured with a dynamic light scattering particle size distribution analyzer (“Zetasizer Nano ZS” manufactured by Malvern Instruments, Ltd.), unless otherwise specified.

The content of pigment particles in the ink according to this embodiment is preferably not less than 6.0% by mass and not more than 20.0% by mass, and more preferably not less than 10.0% by mass and not more than 15.0% by mass. When the content of pigment particles is not less than 5.0% by mass, the ink according to this embodiment enables easier formation of an image having a desired image density. Furthermore, when the content of pigment particles is not more than 20.0% by mass, the ink according to this embodiment can be optimized in terms of fluidity.

### (Pigment)

Examples of the pigment include a yellow pigment, an orange-colored pigment, a red pigment, a blue pigment, a violet pigment, and a black pigment. Examples of the yellow pigment include C.I. Pigment Yellows (74, 93, 95, 109, 110, 120, 128, 138, 139, 151, 154, 155, 173, 180, 185, and 193). Examples of the orange-colored pigment include C.I. Pigment Oranges (34, 36, 43, 61, 63, and 71). Examples of the red pigment include C.I. Pigment Reds (122 and 202). An example of the blue pigment is C.I. Pigment Blue (15, and more specifically 15:3). Examples of the violet pigment include C.I. Pigment Violets (19, 23, and 33). An example of the black pigment is C.I. Pigment Black (7).

The content of pigment in the ink according to this embodiment is preferably not less than 3.0 parts by mass and not more than 15.0 parts by mass, and more preferably not less than 7.0 parts by mass and not more than 12.0 parts by mass. The content of pigment in the pigment particle is preferably not less than 45.0% by mass and not more than 80.0% by mass, and more preferably not less than 55.0% by mass and not more than 70.0% by mass.

### (Cross-Linked Resin)

The content of cross-linked resin in the ink according to this embodiment is preferably not less than 0.5% by mass and not more than 10.0% by mass, and more preferably not less than 2.0% by mass and not more than 4.5% by mass. When the content of cross-linked resin is not less than 0.5% by mass, the dispersion stability of the pigment particles can be further optimized. When the content of cross-linked resin is not more than 10.0% by mass, the generation of free resin can be reduced.

In the pigment particles, the content of cross-linked resin relative to 100 parts by mass of pigment is preferably not less than 25 parts by mass and not more than 60 parts by mass, and more preferably not less than 30 parts by mass and not more than 45 parts by mass. When the content of cross-linked resin relative to 100 parts by mass of pigment is not less than 25 parts by mass and not more than 60 parts by mass, the dispersion stability of the pigment particles can be further optimized.

### (Specific Resin)

As described previously, the specific resin is a neutralized product of the copolymer described previously. The percentage of neutralization of the specific resin is not less than 20% and not more than 100%, preferably not less than 40% and not more than 95%, and more preferably not less than 50% and not more than 70%. When the percentage of neutralization of the specific resin is not less than 20% and not more than 100%, the cross-linked resin can be given moderately high hydrophilicity to optimize the dispersion stability of the pigment particles.

The specific resin preferably contains alkali metal atoms. In other words, the specific resin is preferably a neutralized product obtained by neutralizing the copolymer with a neutralizer containing alkali metal atoms. The alkali metal atoms are not volatilized from the ink according to this embodiment even when the ink according to this embodiment is exposed to a dry condition. Therefore, since the copolymer is neutralized with a neutralizer containing alkali metal atoms, the neutralized state (hydrophilicity) of the cross-linked resin is maintained even when the ink according to this embodiment is exposed to a dry condition. The preferred alkali metal atoms are potassium atoms or sodium atoms. The preferred neutralizer is a hydroxide containing alkali metal atoms and the more preferred neutralizer is NaOH or KOH.

As described previously, the copolymer as a constituent of the specific resin has first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate.

Examples of alkylene glycol (meth)acrylate include ethylene glycol (meth)acrylate, propylene glycol (meth)acrylate, and butylene glycol (meth)acrylate and, among them, the preferred alkylene glycol (meth)acrylate is ethylene glycol (meth)acrylate.

Examples of dialkylene glycol (meth)acrylate include diethylene glycol (meth)acrylate, dipropylene glycol (meth)acrylate, and dibutylene glycol (meth)acrylate and, among them, the preferred alkylene glycol (meth)acrylate is dipropylene glycol (meth)acrylate.

The respective contents of the first to fourth repeating units in the specific resin are as follows. The content of the first repeating unit is, relative to 100% by mass of all the repeating units, not less than 1% by mass and not more than 65% by mass, preferably not less than 15% by mass and not more than 55% by mass, more preferably not less than 25% by mass and not more than 50% by mass, and even more preferably not less than 40% by mass and not more than 48% by mass. When the content of the first repeating unit is not less than 1% by mass and not more than 65% by mass, the dispersion stability of the pigment particles can be further optimized.

The content of the second repeating unit is, relative to 100% by mass of all the repeating units, not less than 1% by mass and not more than 60% by mass, preferably not less than 10% by mass and not more than 40% by mass, and more preferably not less than 15% by mass and not more than 27% by mass. When the content of the second repeating unit is not less than 1% by mass and not more than 60% by mass, the dispersion stability of the pigment particles can be further optimized.

The content of the third repeating unit is, relative to 100% by mass of all the repeating units, not less than 10% by mass and not more than 40% by mass, preferably not less than 20% by mass and not more than 35% by mass, and more preferably not less than 25% by mass and not more than 32% by mass. When the content of the third repeating unit is not less than 10% by mass and not more than 40% by mass, the dispersion stability of the pigment particles can be further optimized.

The content of the fourth repeating unit is, relative to 100% by mass of all the repeating units, not less than 1% by mass and not more than 12% by mass, preferably not less than 4% by mass and not more than 11% by mass, and more preferably not less than 4% by mass and not more than 8% by mass. When the content of the fourth repeating unit is not less than 1% by mass and not more than 12% by mass, the dispersion stability of the pigment particles can be further optimized.

The respective contents of the first repeating unit, the second repeating unit, the third repeating unit, and the fourth repeating unit in the specific resin are particularly preferably, relative to 100% by mass of all the repeating units, not less than 15% by mass and not more than 55% by mass, not less than 10% by mass and not more than 40% by mass, not less than 20% by mass and not more than 35% by mass, and not less than 4% by mass and not more than 11% by mass, respectively. Thus, the dispersion stability of the pigment particles can be even further optimized.

The copolymer may be a random copolymer or a block copolymer. Among them, the preferred copolymer is a random copolymer.

The composition of monomers as source materials for the copolymer is preferably any one of Compositions 1 to 3 shown in Table 1 below. In Table 1, each of the ranges of numerical values indicates a preferred range of contents [% by mass]. For example, “18-22” in Styrene of Composition 1 indicates that the composition contains styrene in a range from 18% by mass to 22% by mass, both inclusive.

TABLE 1

| | | | Ethylene | Dipropylene | | |
|---|---|---|---|---|---|---|
| | | | Glycol | Glycol | Acrylic | Methacrylic |
| | Styrene | α-Methylstyrene | Acrylate | Acrylate | Acid | Acid |
| Composition 1 | 18-22 | 38-42 | 3-7 | — | — | 23-27 |
| Composition 2 | 48-52 | 18-22 | — | 7-11 | 11-15 | — |
| Composition 3 | 13-17 | 13-17 | 0.5-2 | — | — | 18-22 |

### (Cross-Linking Agent)

The cross-linking agent constituting the cross-linked resin together with the specific resin is preferably a specific cross-linking agent that contains a polyfunctional epoxy compound (X) having, in its molecule, two or more epoxy groups and one or more hydroxy groups and has a water solubility of 80% or more.

Because the specific cross-linking agent has, in its molecule, two or more epoxy groups which are cross-linkable groups having excellent reactivity, it can efficiently form a cross-linking structure with the specific resin. Since the specific cross-linking agent has, in its molecule, one or more hydroxy groups, the cross-linked resin can maintain a moderately high degree of hydrophilicity. By adjusting the water solubility of the specific cross-linking agent to 80% or more, the dispersion stability of the pigment particles can be further optimized.

The water solubility of the specific cross-linking agent is preferably not less than 80%, more preferably not less than 90%, and even more preferably not less than 98%.

The water solubility of the cross-linking agent means, in the case of mixing of 10 g of the cross-linking agent with 90 g of water at 25° C., the rate (100×A/10 g) of the mass A of the cross-linking agent dissolved in the water relative to the total amount (10 g) of the cross-linking agent. For example, when, in the case of mixing of 10 g of cross-linking agent with 90 g of water at 25° C., 9 g of the cross-linking agent is dissolved in the water and 1 g of the cross-linking agent is not dissolved in and precipitates out of the water (i.e., the mass A is 9 g), the water solubility is 90%.

In the polyfunctional epoxy compound (X), the number of epoxy groups in its molecule is preferably not less than 2 and not more than 8, and more preferably not less than 2 and not more than 5. In the polyfunctional epoxy compound (X), the number of hydroxy groups in its molecule is preferably not less than 1 and not more than 5, and more preferably not less than 1 and not more than 3.

The polyfunctional epoxy compound (X) to be used is preferably glycerol polyglycidyl ether, polyglycerol polyglycidyl ether (particularly, diglycerol polyglycidyl ether or triglycerol polyglycidyl ether) or sorbitol polyglycidyl ether, and more preferably glycerol polyglycidyl ether, diglycerol polyglycidyl ether or triglycerol polyglycidyl ether.

The specific cross-linking agent may further contain a polyfunctional epoxy compound (Y) other than the polyfunctional epoxy compound (X). The preferred other polyfunctional epoxy compound (Y) is a compound (glycerin triglycidyl ether) represented by the chemical formula (2) below. The total content of the polyfunctional epoxy compound (X) and glycerin triglycidyl ether in the specific cross-linking agent is preferably not less than 80% by mass, more preferably not less than 95% by mass, and even more preferably 100% by mass.

Examples of the polyfunctional epoxy compound (X) include compounds represented by the chemical formulas (1), (3), (4), and (5) below. The preferred specific cross-linking agent is a mixture of a compound represented by the chemical formula (1) below and a compound represented by the chemical formula (2) below, a compound represented by the chemical formula (3) below, a compound represented by the chemical formula (4) below or a compound represented by the chemical formula (5) below.

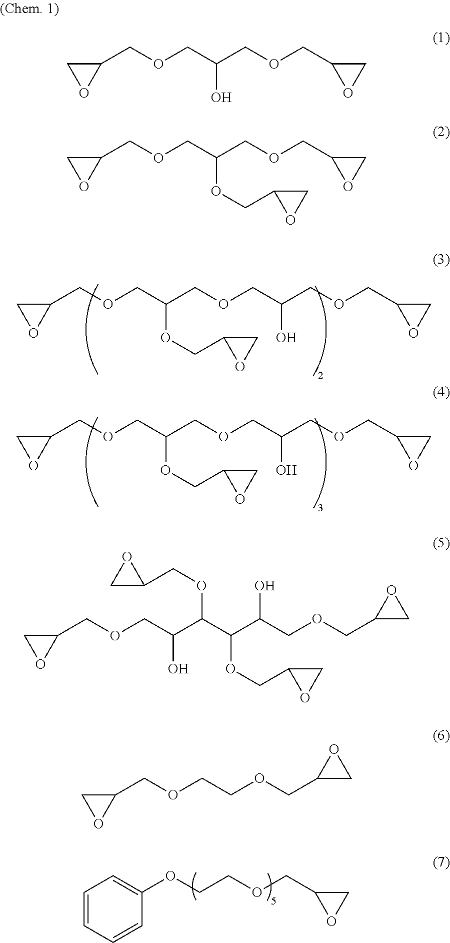

The epoxy equivalent of the specific cross-linking agent is preferably not less than 100 g/eq. and not more than 250 g/eq., more preferably not less than 130 g/eq. and not more than 200 g/eq., and even more preferably not less than 130 g/eq. and not more than 170 g/eq. The epoxy equivalent can be determined, for example, according to the method described in JIS K 7236:2009.

### [Surfactant]

The ink according to this embodiment preferably further contains a surfactant. With the use of the surfactant, the penetration (wettability) of the ink according to this embodiment into a recording medium can be optimized. Examples of the surfactant include an anionic surfactant, a cationic surfactant, and a non-ionic surfactant. The preferred surfactant is a non-ionic surfactant.

Examples of the non-ionic surfactant include polyoxyethylene dodecyl ether, polyoxyethylene hexadecyl ether, polyoxyethylene nonylphenyl ether, polyoxyethylene sorbitan monooleate ether, monodecanoyl sucrose, and an ethylene oxide adduct of acetylene glycol. Among them, the preferred non-ionic surfactant is an ethylene oxide adduct of acetylene glycol.

The content of surfactant in the ink according to this embodiment is preferably not less than 0.05% by mass and not more than 3.0% by mass, and more preferably not less than 0.1% by mass and not more than 0.5% by mass.

### [Other Components]

As necessary, the ink according to this embodiment may further contain a known additive (at least one of, for example, a dissolution stabilizer, an anti-drying agent, an antioxidant, a viscosity modifier a pH adjuster, and a fungicide).

### <Production Method of Ink>

Next, a description will be given of an example of a method for producing the ink according to this embodiment. The method for producing the ink includes, for example, a neutralization step of neutralizing a copolymer as described previously to prepare a specific resin; a dispersion step of dispersing a pigment and the specific resin into water to prepare a dispersion liquid of pigment particles; a cross-linking step of adding a cross-linking agent into the dispersion liquid of pigment particles to produce a cross-linked resin; and an addition step of adding an aqueous vehicle into the dispersion liquid of pigment particles subjected to the cross-linking treatment to prepare an ink.

### (Neutralization Step)

In the neutralization step, a specific resin is prepared by neutralizing the copolymer. An example of the method for neutralizing the copolymer is a method of mixing the copolymer and a neutralizer (for example, an aqueous alkali).

### (Dispersion Step)

In the dispersion step, a dispersion liquid of pigment particles is prepared by dispersing a pigment and the specific resin into water. An example of a disperser for use in the dispersion step is a wet disperser, such as a medium disperser.

In the dispersion step, the content of the specific resin in a solution for use in the dispersion treatment is, for example, not less than 4.0% by mass and not more than 25.0% by mass. The content of pigment in the solution for use in the dispersion treatment is, for example, not less than 1.0% by mass and not more than 15.0% by mass. The solution for use in the dispersion treatment preferably further contains a defoamer. The content of defoamer in the solution for use in the dispersion treatment is, for example, not less than 0.01% by mass and not more than 0.1% by mass.

### (Filtration Step)

In the filtration step, coarse particles are preferably filtered out of the obtained dispersion liquid of pigment particles using a filter (having a pore diameter of not less than 0.5 μm and less than 1.0 μm).

### (Cross-Linking Step)

In the cross-linking step, a cross-linking agent (preferably, a specific cross-linking agent as described previously) is added to the dispersion liquid of pigment particles. Thus, the specific resin contained in the dispersion liquid of pigment particles reacts with the cross-linking agent and is thus cross-linked. As a result, a cross-linked resin is produced as a reaction product of the cross-linking agent and the specific resin. In the cross-linking step, it is preferred that the dispersion liquid of pigment particles after the addition of the cross-linking agent thereinto is heated while being stirred. The preferred heating temperature is, for example, not lower than 70° C. and not higher than 95° C. The preferred heating time is, for example, not less than two minutes and not more than six hours.

### (Addition Step)

In the addition step, an aqueous vehicle is added into the dispersion liquid of pigment particles after being subjected to the cross-linking treatment. Thus, an ink can be obtained. In the addition step, as necessary, another component (specifically, at least one of a surfactant, a dissolution stabilizer, a humectant, a penetrant, and a viscosity modifier) may be further added. In the addition step, a mixture liquid obtained after the addition of the aqueous vehicle is preferably stirred with a stirrer. Foreign matter and coarse particles may be filtered out of the obtained ink using a filter (for example, a filter with a pore diameter of 5 μm or less).

Hereinafter, a description will be given of effects of the ink according to this embodiment with reference to examples. However, the present disclosure is not limited to the following examples.

### [Preparation of Resin (R-1)]

An amount of 100.0 parts by mass of isopropyl alcohol and 250.0 parts by mass of methyl ethyl ketone were introduced into a four-necked flask equipped with a stirrer, a nitrogen introduction tube, a condenser, and a dripping funnel. Separately, 20.0 parts by mass of styrene, 40.0 parts by mass of α-methylstyrene, 5.0 parts by mass of ethylene glycol acrylate, 25.0 parts by mass of methacrylic acid, and 0.3 parts by mass of azo-bis-isobutyronitrile (AIBN, a polymerization initiator) were mixed to prepare a monomer solution. Furthermore, 150.0 parts by mass of methyl ethyl ketone and 0.1 parts by mass of AIBN were mixed to prepare a methyl ethyl ketone solution.

Next, nitrogen gas was introduced into the above-described four-necked flask and, thus, the interior of the flask was placed under nitrogen atmosphere. Next, while the contents of the four-necked flask were heated at 70° C. to reflux, the full amount of the monomer solution was added dropwise through the dripping funnel into the four-necked flask over two hours. After the addition of the monomer solution, the contents of the four-necked flask were further heated at 70° C. to reflux over six hours. Next, while the contents of the four-necked flask were heated at 70° C. to reflux, the full amount of the methyl ethyl ketone solution was added dropwise through the dripping funnel into the four-necked flask over 15 minutes. After the addition of the methyl ethyl ketone solution, the contents of the four-necked flask were further heated at 70° C. to reflux over five hours. Thus, a resin aqueous solution containing a resin (R-1) was obtained. Methyl ethyl ketone and isopropyl alcohol were distilled away from the resin aqueous solution, thus isolating the resin (R-1).

### [Preparation of Resins (R-2) to (R-15)]

Resins (R-2) to (R-15) were prepared in the same manner as in the preparation of the resin (R-1) except that, in preparing a monomer solution, the type and amount of monomer used were changed as shown in Table 2 below. In Table 2, “EG acrylate” represents ethylene glycol acrylate and “DPGA” represents dipropylene glycol acrylate.

(Neutralization Treatment: Preparation of Resin Aqueous Solutions (r-1) to (r-15))

Each of the resins (specifically, any one of Resins (R-1) to (R-15)) shown in Table 2, potassium hydroxide, and water were mixed, thus obtaining resin aqueous solutions (r-1) to (r-15). A neutralized resin was contained in each of the resin aqueous solutions (r-1) to (r-15). The amount of potassium hydroxide added was adjusted to an amount at which the percentage of neutralization of the neutralized resin reached 60%. The amount of water added was adjusted to an amount at which the solid content concentration of each of the resin aqueous solutions (r-1) to (r-15) (i.e., the content of the neutralized resin) reached 30% by mass.

TABLE 2

| | | Resin Aqueous Solution | | | | |
|---|---|---|---|---|---|---|
| | | r-1 | r-2 | r-3 | r-4 | r-5 |
| | | Resin | | | | |
| | | R-1 | R-2 | R-3 | R-4 | R-5 |
| Monomer | styrene | 20 | 60 | — | 5 | 40 |
| (parts by mass) | α-methylstyrene | 40 | 10 | 50 | 70 | — |
| | EG acrylate | 5 | 4 | 5 | — | 5 |
| | DPGA | — | — | — | 5 | — |
| | acrylic acid | — | 20 | 25 | — | 20 |
| | methacrylic acid | 25 | — | — | 20 | |
| | | Resin Aqueous Solution | | | | |
| | | r-6 | r-7 | r-8 | r-9 | r-10 |
| | | Resin | | | | |
| | | R-6 | R-7 | R-8 | R-9 | R-10 |
| Monomer | styrene | 35 | 20 | 30 | 30 | 17 |
| (parts by mass) | α-methylstyrene | 35 | 40 | 35 | 60 | 63 |
| | EG acrylate | 15 | — | 10 | 8 | 5 |
| | DPGA | — | — | — | — | — |
| | acrylic acid | — | 35 | 55 | — | 15 |
| | methacrylic acid | 30 | — | — | — | — |
| | | Resin Aqueous Solution | | | | |
| | | r-11 | r-12 | r-13 | r-14 | r-15 |
| | | Resin | | | | |
| | | R-11 | R-12 | R-13 | R-14 | R-15 |
| Monomer | styrene | 59 | 42 | 28 | 37 | 40 |
| (parts by mass) | α-methylstyrene | 21 | 42 | 28 | 37 | 1 |
| | EG acrylate | 5 | 5 | 5 | 11 | 5 |
| | DPGA | — | — | — | — | — |
| | acrylic acid | 15 | 11 | 39 | 15 | 20 |
| | methacrylic acid | — | — | — | — | — |

For each of the resins (R-1) to (R-15), the respective contents [% by mass] of the first to fourth repeating units are shown in Table 3 below.

TABLE 3

| Resin | R-1 | R-2 | R-3 | R-4 | R-5 |
|---|---|---|---|---|---|
| First | 44 | 11 | 63 | 70 | — |
| Second | 22 | 64 | — | 5 | 61 |
| Third | 28 | 21 | 31 | 20 | 31 |
| Fourth | 6 | 4 | 6 | 5 | 8 |
| Resin | R-6 | R-7 | R-8 | R-9 | R-10 |
| First | 30.5 | 42 | 27 | 61 | 63 |
| Second | 30.5 | 21 | 23 | 31 | 17 |
| Third | 26 | 37 | 42 | — | 15 |
| Fourth | 13 | — | 8 | 8 | 5 |
| Resin | R-11 | R-12 | R-13 | R-14 | R-15 |
| First | 21 | 42 | 28 | 37 | 2 |
| Second | 59 | 42 | 28 | 37 | 60 |
| Third | 15 | 11 | 39 | 15 | 30 |
| Fourth | 5 | 5 | 5 | 11 | 8 |

As shown in Table 3, the resin (R-1) and resins (R-10) to (R-15) were specific resins in which the respective contents of the first repeating unit, the second repeating unit, the third repeating unit, and the fourth repeating unit were, relative to 100% by mass of all the repeating units, not less than 1% by mass and not more than 65% by mass, not less than 1% by mass and not more than 60% by mass, not less than 10% by mass and not more than 40% by mass, and not less than 1% by mass and not more than 12% by mass, respectively.

Particularly, in the resin (R-1), the respective contents of the first repeating unit, the second repeating unit, the third repeating unit, and the fourth repeating unit were, relative to 100% by mass of all the repeating units, not less than 15% by mass and not more than 55% by mass, not less than 10% by mass and not more than 40% by mass, not less than 20% by mass and not more than 35% by mass, and not less than 4% by mass and not more than 11% by mass, respectively. In other words, the resin (R-1) was a specific resin in which the respective contents of the first to fourth repeating units were within the respective more preferred ranges.

On the other hand, the resins (R-2) to (R-9) were resins in which the respective contents of the first to fourth repeating units fell outside the above respective ranges (i.e., were not specific resins).

### <Preparation of Ink>

Inks in Examples 1 to 15 (Ex. 1 to Ex. 15) and Comparative Examples 1 to 9 (CEx. 1 to CEx. 9) were prepared according to the following method. The manufacturer and product names of cross-linking agents used are described below. The chemical names, chemical formulas, epoxy equivalents, and water solubilities of the cross-linking agents are shown in Table 4 below. In Table 4, “(1)+ (2)” in Chemical Formula for the cross-linking agent (EX-313) means that the cross-linking agent contains a compound represented by the above-described chemical formula (1) and a compound represented by the above-described chemical formula (2).

Cross-linking agent (EX-313): “DENACOL (registered trademark) EX-313” manufactured by Nagase ChemteX Corporation

Cross-linking agent (EX-512): “DENACOL (registered trademark) EX-512” manufactured by Nagase ChemteX Corporation

Cross-linking agent (EX-521): “DENACOL (registered trademark) EX-521” manufactured by Nagase ChemteX Corporation

Cross-linking agent (EX-614B): “DENACOL (registered trademark) EX-614B” manufactured by Nagase ChemteX Corporation

Cross-linking agent (EX-612): “DENACOL (registered trademark) EX-612” manufactured by Nagase ChemteX Corporation

Cross-linking agent (EX-810): “DENACOL (registered trademark) EX-810” manufactured by Nagase ChemteX Corporation

Cross-linking agent (EX-145): “DENACOL (registered trademark) EX-145” manufactured by Nagase ChemteX Corporation

TABLE 4

| | | | Epoxy | Water |
|---|---|---|---|---|
| | | Chemical | Equivalent | Solubility |
| | Chemical Name | Formula | (g/eq.) | (% by mass) |
| EX-313 | glycerol polyglycidyl ether | (1) + (2) | 141 | 99 |
| EX-512 | polyglycerol polyglycidyl ether | (3) | 168 | 100 |
| EX-521 | polyglycerol polyglycidyl ether | (4) | 183 | 100 |
| EX-614B | sorbitol polyglycidyl ether | (5) | 173 | 94 |
| EX-612 | sorbitol polyglycidyl ether | (5) | 166 | 42 |
| EX-810 | ethylene glycol diglycidyl ether | (6) | 113 | 100 |
| EX-145 | phenol (EO)₅ glycidyl ether | (7) | 400 | 100 |

Among the above cross-linking agents, the cross-linking agents (EX-313), (EX-512), (EX-521), and (EX-614B) are specific cross-linking agents each of which is a polyfunctional epoxy compound (X) having, in its molecule, two or more epoxy groups and one or more hydroxy groups and has a water solubility of 80% or more.

### [Preparation of Ink in Example 1]

### (Dispersion Treatment)

An amount of 15.0 parts by mass of pigment (“Printex (registered trademark) 80” by Orion Engineered Carbons, carbon black), 15.0 parts by mass of resin aqueous solution (r-1) (containing 4.5 parts by mass of neutralized resin (R-1)), 0.1 parts by mass of defoamer (“SN-DEFOAMER 1340” manufactured by San Nopco Limited, amide wax-based surfactant), and ion-exchange water were mixed, thus obtaining a mixture. The amount of ion-exchange water added was adjusted to an amount at which the amount of the mixture reached 100 parts by mass.

The above mixture was subjected to dispersion treatment for four hours with a medium disperser (“DYNO-MILL” manufactured by Willy A. Bachofen (WAB) AG). In the dispersion treatment, zirconia beads with a diameter of 0.5 mm were used as a medium. The loading rate of the medium was set to 60% by volume relative to the capacity of the vessel. The treatment temperature (chiller temperature) during the dispersion treatment was set to 10° C. After the dispersion treatment, the medium was removed from the contents of the medium disperser, thus obtaining a dispersion liquid of pigment particles.

### (Filtration Treatment)

Next, the obtained dispersion liquid of pigment particles was filtered by a filter having a pore diameter of 0.5 μm or 1.0 μm, thus removing foreign matter and coarse particles from the dispersion liquid.

### (Cross-Linking Treatment)

A three-necked flask equipped with a thermometer and stirring blades was used as a reactor. An amount of 100.0 parts by mass of dispersion liquid of pigment particles after being subjected to filtration was introduced into the reactor. The temperature of the contents of the reactor was maintained at 30° C. using a water bath. Next, 0.82 parts by mass of cross-linking agent (EX-313) was introduced into the reactor. Next, the contents of the reactor were stirred at 250 rpm for an hour. Next, the contents of the reactor were increased in temperature to 80° C. at a rate of temperature increase of 0.5° C./min., with stirring at 250 rpm. Next, the contents of the reactor were stirred at 250 rpm for four hours while keeping the temperature thereof at 80° C. Thus, the contents of the reactor were reacted. By the reaction, the neutralized resin (R-1) was cross-linked with the cross-linking agent (EX-313), thus forming a cross-linked resin. Next, the contents of the reactor were allowed to cool to room temperature. Thus, the dispersion liquid of pigment particles subjected to the cross-linking treatment was obtained.

### (Addition Treatment)

The following components were introduced into a container to have Composition 1 shown in Table 5 below. Specifically, in Example 1, relative to 100 parts by mass of the entire mixture liquid, 60.0 parts by mass of dispersion liquid of pigment particles (containing approximately 9 parts by mass of pigment and approximately 3 parts by mass of resin), 20.0 parts by mass of ethylene glycol, 15.0 parts by mass of diethyl diglycol, 0.3 parts by mass of non-ionic surfactant (“OLFINE (registered trademark) E1004” manufactured by Nissin Chemical Industry Co., Ltd), and 4.7 parts by mass of ion-exchange water were introduced into the container. The contents of the container were stirred under a condition of a rotational speed of 400 rpm using a stirrer (Three-One motor BL-600″ manufactured by Shinto Scientific Co., Ltd.), thus obtaining a mixture liquid. The obtained mixture liquid was filtered by a filter (having a pore diameter of 5 μm). Thus, an ink in Example 1 was obtained.

### [Preparation of Inks in Examples 2 to 15 and Comparative Examples 1 to 9]

Inks in Examples 2 to 15 and Comparative Examples 1 to 9 were prepared in the same manner as in the preparation of the ink in Example 1 except that the type of the resin dispersion liquid, the type and amount of cross-linking agent used, and the composition in addition treatment (any one of Compositions 1 to 3 in Table 5) were changed as shown in Table 6 below.

### [Measurement of Number of Coarse Particles]

Each of the prepared inks was subjected to an AccuSizer test described below to measure the number of coarse particles. The measurement results are shown in Table 6.

### (AccuSizer Test)

(Conditions of Settings) measurement device: “AccuSizer Model 780” manufactured by PSS (Particle Sizing Systems), time of collection: 60 seconds, number of channels: 128, container fluid volume: 60 ml, flow rate: 60 ml/min., maximum match: 9000, number of cycles: 1

### (Sample Separation)

An amount of 2 mL of diluted sample was poured into an AccuSizer container. The total number per mL of particles having a diameter larger than 0.5 μm or 1 μm were recorded and the total number was adjusted to reflect the concentration of particles modified to an appropriate solid level with respect to mL of the initial dispersion liquid.

TABLE 5

| | | Composition | Composition | Composition |
|---|---|---|---|---|
| | | 1 | 2 | 3 |
| Composition | dispersion liquid of pigment particles | 60.0 | 60.0 | 60.0 |
| (parts by mass) | ethylene glycol | 20.0 | — | — |
| | diethyl diglycol | 15.0 | — | — |
| | glycerin | — | 9.6 | — |
| | triethylene glycol monobutyl ether | — | 12.0 | 8.4 |
| | 3-methyl-1,5-pentanediol | — | 12.0 | — |
| | 2-pyrrolidone | — | 1.6 | 1.7 |
| | 1,3-propanediol | — | — | 12.5 |
| | 1,5-pentanediol | — | — | 12.5 |
| | non-ionic surfactant | 0.3 | 0.3 | 0.3 |
| | water | rest | rest | rest |
| | total | 100.0 | 100.0 | 100.0 |

TABLE 6

| | | | | | | Number of |
|---|---|---|---|---|---|---|
| | Resin | Cross-Linking Agent | | Composition | Filter Pore | Coarse |
| | Dispersion | | Amount Added | in Addition | Diameter | Particles |
| | Liquid | Type | (parts by mass) | Treatment | (μm) | (×10⁵/mL) |
| Ex. 1 | r-1 | EX-313 | 0.82 | 1 | 0.5 | 1076 |
| Ex. 2 | r-1 | EX-512 | 1.19 | 2 | 0.5 | 914 |
| Ex. 3 | r-1 | EX-521 | 1.87 | 1 | 0.5 | 959 |
| Ex. 4 | r-1 | EX-614B | 0.75 | 3 | 0.5 | 952 |
| Ex. 5 | r-1 | EX-313 | 0.82 | 1 | 0.8 | 1398 |
| Ex. 6 | r-1 | EX-612 | 0.82 | 1 | 0.5 | 1043 |
| Ex. 7 | r-1 | EX-810 | 1.19 | 1 | 0.5 | 916 |
| Ex. 8 | r-1 | EX-145 | 1.87 | 1 | 0.5 | 1033 |
| Ex. 9 | r-1 | — | — | 1 | 0.5 | 936 |
| Ex. 10 | r-10 | EX-313 | 0.82 | 1 | 0.5 | 1028 |
| Ex. 11 | r-11 | EX-313 | 0.82 | 1 | 0.5 | 975 |
| Ex. 12 | r-12 | EX-313 | 0.82 | 1 | 0.5 | 990 |
| Ex. 13 | r-13 | EX-313 | 0.82 | 1 | 0.5 | 968 |
| Ex. 14 | r-14 | EX-313 | 0.82 | 1 | 0.5 | 1007 |
| Ex. 15 | r-15 | EX-313 | 0.82 | 1 | 0.5 | 988 |
| CEx. 1 | r-2 | EX-313 | 0.82 | 1 | 0.5 | 906 |
| CEx. 2 | r-3 | EX-313 | 0.82 | 1 | 0.5 | 969 |
| CEx. 3 | r-4 | EX-313 | 0.82 | 1 | 0.5 | 998 |
| CEx. 4 | r-5 | EX-313 | 0.82 | 1 | 0.5 | 1019 |
| CEx. 5 | r-6 | EX-313 | 0.82 | 1 | 0.5 | 1079 |
| CEx. 6 | r-7 | EX-313 | 0.82 | 1 | 0.5 | 1074 |
| CEx. 7 | r-8 | EX-313 | 0.82 | 1 | 0.5 | 1059 |
| CEx. 8 | r-9 | EX-313 | 0.82 | 1 | 0.5 | 1097 |
| CEx. 9 | r-1 | EX-313 | 0.82 | 1 | 1.0 | 1891 |

### <Evaluations>

Each of the inks in Examples 1 to 15 (Ex. 1 to Ex. 15) and Comparative Examples 1 to 9 (CEx. 1 to CEx. 9) was evaluated in terms of nozzle clogging, image density of the image formed, and in-apparatus contamination. The evaluation results are shown in Table 7 below.

### [Apparatus for Evaluation]

As an apparatus for evaluation, a line head-mounted ink-jet recording apparatus (“TASKalfa Pro 15000c” manufactured by KYOCERA Document Solutions Inc.) was used. Each of the inks in Examples 1 to 15 and Comparative Examples 1 to 9 as subjects to evaluation was loaded into a black ink tank of the apparatus for evaluation.

### [Nozzle Clogging]

The evaluation of nozzle clogging was conducted in an environment at a temperature of 25° C. and a humidity of 60% RH. Ink-jet matte paper (“SuperFine Paper” manufactured by Seiko Epson Corporation) was used as recording media. Using the apparatus for evaluation, a solid image (150 mm×200 mm) was continuously formed on 100 recording media. Next, purge processing for purging ink from the recording head of the apparatus for evaluation was done. Next, wiping processing for wiping the ink ejection surface of the recording head of the apparatus for evaluation with a cleaning wiper was done.

Next, using the apparatus for evaluation, a nozzle check pattern was formed on matte paper described above. As a result, regarding all the subjects to evaluation, it was confirmed that ink had been ejected through all the nozzles (7968 nozzles). In other words, the number of nozzles caused clogging was zero. Next, the recording head of the apparatus for evaluation was subjected to the above-described purge processing and wiping processing. Next, the apparatus for evaluation was allowed to stand for three days with its recording head uncapped. Next, the recording head of the apparatus for evaluation was subjected to the above-described purge processing and wiping processing.

Next, using the apparatus for evaluation, a nozzle check pattern was formed on matte paper described above. The formed nozzle check pattern was observed to check the number of nozzles caused clogging. The percentage of the number of nozzles caused clogging with respect to the total number of nozzles in the recording head of the apparatus for evaluation was used as an evaluation value for nozzle clogging. Each ink was determined in terms of nozzle clogging in accordance with the following criteria.

### (Nozzle Clogging Criteria)

A (very good): The evaluation value was less than 5%.

B (good): The evaluation value was not less than 5% and less than 10%.

C (poor): The evaluation value was not less than 10%.

### [Image Density]

The evaluation of image density was conducted in an environment at a temperature of 25° C. and a humidity of 50% RH. PPC paper (“C2” manufactured by FUJIFILM Business Innovation Corporation) was used as recording media. Using the apparatus for evaluation, a solid image with 10 cm×10 cm was formed on a recording medium. In forming the solid image, the apparatus for evaluation was set up so that the volume of ink per droplet ejected from the recording head was 11 pL (11 pL of ink per pixel). The image density of the formed solid image was measured with a reflection densitometer (“RD-19” manufactured by X-Rite, Incorporated). In measuring the image density, the image densities of 10 spots selected randomly within the solid image were measured and the arithmetic mean value of the 10 image densities was adopted as an evaluation value (ID) for the image density. Each ink was determined in terms of image density in accordance with the following criteria.

### (Image Density Criteria)

A (good): ID was 1.15 or more.

B (poor): ID was less than 1.15.

### [In-Apparatus Contamination]

The evaluation of in-apparatus contamination was conducted in an environment at a temperature of 25° C. and a humidity of 60% RH. Ink-jet matte paper (“SuperFine Paper” manufactured by Seiko Epson Corporation) was used as recording media. Using the apparatus for evaluation, a solid image (150 mm×200 mm) was continuously formed on 5000 recording media. Thereafter, the recording head in the apparatus for evaluation was visually checked for how much in-apparatus contamination with ink mist has occurred. Each ink was determined in terms of in-apparatus contamination in accordance with the following criteria.

### (In-Apparatus Contamination Criteria)

A (good): No problem in visual evaluation

B (poor): Problematic in visual evaluation

TABLE 7

| | Nozzle Clogging | | | | |
|---|---|---|---|---|---|
| | Evaluation | | | | In-Apparatus |
| | Value | | Image Density | | Contamination |
| | (%) | Determination | ID | Determination | Determination |
| Ex. 1 | 3 | A | 1.19 | A | A |
| Ex. 2 | 2 | A | 1.18 | A | A |
| Ex. 3 | 4 | A | 1.17 | A | A |
| Ex. 4 | 2 | A | 1.18 | A | A |
| Ex. 5 | 4 | A | 1.19 | A | A |
| Ex. 6 | 6 | B | 1.18 | A | A |
| Ex. 7 | 6 | B | 1.18 | A | A |
| Ex. 8 | 9 | B | 1.18 | A | A |
| Ex. 9 | 6 | B | 1.18 | A | A |
| Ex. 10 | 6 | B | 1.17 | A | A |
| Ex. 11 | 7 | B | 1.18 | A | A |
| Ex. 12 | 7 | B | 1.17 | A | A |
| Ex. 13 | 6 | B | 1.15 | A | A |
| Ex. 14 | 9 | B | 1.15 | A | A |
| Ex. 15 | 8 | B | 1.16 | A | A |
| CEx. 1 | 13 | C | 1.15 | A | A |
| CEx. 2 | 12 | C | 1.17 | A | A |
| CEx. 3 | 11 | C | 1.20 | A | A |
| CEx. 4 | 12 | C | 1.19 | A | A |
| CEx. 5 | 14 | C | 1.09 | B | A |
| CEx. 6 | 12 | C | 1.18 | A | A |
| CEx. 7 | 11 | C | 1.11 | B | A |
| CEx. 8 | 13 | C | 1.19 | A | A |
| CEx. 9 | 3 | A | 1.17 | A | B |

### Example 1 to Example 5

In each of the inks in Examples 1 to 5, the resin contained in the pigment particle was a specific resin (specifically, the resin (R-1) in which the respective contents of the first to fourth repeating units were within the respective more preferred ranges). The added cross-linking agent was a specific cross-linking agent (specifically, any one of EX-313, EX-512, EX-521, and EX-614B). As a result, these inks were determined to be very good in terms of nozzle clogging and images having image densities determined to be good were formed using these inks. Furthermore, since each of the number concentrations of coarse particles having a diameter of not less than 0.5 μm and not more than 1.0 μm in these inks was not more than 1500×10⁵/mL, in-apparatus contamination did not occur and, therefore, these inks were determined to be good in terms of in-apparatus contamination.

### Example 6

In the ink in Example 6, the resin contained in the pigment particle was a specific resin (specifically, the resin (R-1)). However, the added cross-linking agent was not a specific cross-linking agent (specifically, the cross-linking agent EX-612 having a water solubility of less than 80%). Therefore, compared to the inks into which a specific cross-linking agent was added, the dispersion stability of pigment particles was determined to be slightly lower. As a result, although an image having an image density determined to be good was formed using the ink, slight nozzle clogging occurred and, therefore, the ink was determined, not to be very good, but to be good in terms of nozzle clogging. On the other hand, since the number concentration of coarse particles not less than 0.5 μm and not more than 1.0 μm in the ink was not more than 1500×10⁵/mL, in-apparatus contamination did not occur and, therefore, the ink was determined to be good in terms of in-apparatus contamination.

### Example 7 and Example 8

In each of the inks in Examples 7 and 8, the resin contained in the pigment particle was a specific resin (specifically, the resin (R-1)). However, the added cross-linking agent was not a specific cross-linking agent (specifically, the cross-linking agent EX-810 or EX-145 having no hydroxy group). Therefore, compared to the inks into which a specific cross-linking agent was added, the hydrophilicity of the cross-linked resin was determined to be lower and the dispersion stability of pigment particles was determined to be slightly lower. As a result, although images having image densities determined to be good were formed using these inks, slight nozzle clogging occurred and, therefore, these inks were determined, not to be very good, but to be good in terms of nozzle clogging. On the other hand, since each of the number concentrations of coarse particles not less than 0.5 μm and not more than 1.0 μm in these inks was not more than 1500×10⁵/mL, in-apparatus contamination did not occur and, therefore, these inks were determined to be good in terms of in-apparatus contamination.

### Example 9

In the ink in Example 9, the resin contained in the pigment particle was a specific resin (specifically, the resin (R-1)). However, since no cross-linking agent was added, the dispersion stability of pigment particles was determined to be slightly lower, compared to the inks into which a specific cross-linking agent was added. As a result, although an image having an image density determined to be good was formed using the ink, slight nozzle clogging occurred and, therefore, the ink was determined, not to be very good, but to be good in terms of nozzle clogging. On the other hand, since the number concentration of coarse particles not less than 0.5 μm and not more than 1.0 μm in the ink was not more than 1500×10⁵/mL, in-apparatus contamination did not occur and, therefore, the ink was determined to be good in terms of in-apparatus contamination.

### Example 10 to Example 15

In each of the inks in Examples 10 to 15, the resin contained in the pigment particle was a specific resin (specifically, the resin (R-10) or the resin (R-15)). The added cross-linking agent was a specific cross-linking agent (specifically, EX-313)). However, since the respective contents of the first to fourth repeating units in the specific resin were out of the respective more preferred ranges, the dispersion stability of pigment particles was determined to be slightly lower, compared to the other inks using the resin (R-1) in which the respective contents of the first to fourth repeating units were within the respective more preferred ranges. As a result, although images having image densities determined to be good were formed using these inks, slight nozzle clogging occurred and, therefore, these inks were determined, not to be very good, but to be good in terms of nozzle clogging. On the other hand, since each of the number concentrations of coarse particles not less than 0.5 μm and not more than 1.0 μm in these inks was not more than 1500×10⁵/mL, in-apparatus contamination did not occur and, therefore, these inks were determined to be good in terms of in-apparatus contamination.

### Comparative Example 1 to Comparative Example 8

In each of the inks in Comparative Examples 1 to 8, the resin contained in the pigment particle was not a specific resin (specifically, it was any one of the resin (R-2) to the resin (R-9)). As a result, these inks were determined to be poor in terms of nozzle clogging. Furthermore, as for the inks in Comparative Examples 1 to 4, 6, and 8, images having image densities determined to be good were formed. However, as for the inks in Comparative Examples 5 and 7, images having image densities determined to be poor were formed. On the other hand, since each of the number concentrations of coarse particles in the inks in Comparative Examples 1 to 8 was not more than 1500×10⁵/mL, in-apparatus contamination did not occur and, therefore, these inks were determined to be good in terms of in-apparatus contamination.

### Comparative Example 9

In the ink in Comparative Example 9, the resin contained in the pigment particle was a specific resin (specifically, the resin (R-1)). The added cross-linking agent was a specific cross-linking agent (specifically, EX-313)). This ink was determined to be very good in terms of nozzle clogging and an image having an image density determined to be good was formed using this ink. However, since the number concentration of coarse particles in this ink was more than 1500×10⁵/mL, in-apparatus contamination occurred and, therefore, this ink was determined to be poor in terms of in-apparatus contamination.

### INDUSTRIAL APPLICABILITY

The ink according to this embodiment can be used in order to form an image.

While the present disclosure has been described in detail with reference to the embodiments thereof, it would be apparent to those skilled in the art that the various changes and modifications may be made therein within the scope defined by the appended claims.

What is claimed is:

1. An ink-jet ink containing an aqueous vehicle and pigment particles dispersed in the aqueous vehicle,
the pigment particle containing a pigment and a specific resin,
the specific resin being a neutralized product of a copolymer having first repeating units derived from α-methylstyrene, second repeating units derived from styrene, third repeating units derived from (meth)acrylic acid, and fourth repeating units derived from alkylene glycol (meth)acrylate or dialkylene glycol (meth)acrylate,
wherein respective contents of the first repeating unit, the second repeating unit, the third repeating unit, and the fourth repeating unit in the specific resin are, relative to 100% by mass of all the repeating units, not less than 1% by mass and not more than 65% by mass, not less than 1% by mass and not more than 60% by mass, not less than 10% by mass and not more than 40% by mass, and not less than 1% by mass and not more than 12% by mass, respectively, and
a number concentration of coarse particles having a diameter of not less than 0.5 μm and not more than 1.0 μm in the ink-jet ink is not more than 1500×10⁵/mL.

2. The ink-jet ink according to claim 1, wherein
the specific resin forms a cross-linked resin by being cross-linked by a specific cross-linking agent, and
the specific cross-linking agent contains a polyfunctional epoxy compound having, in a molecule thereof, two or more epoxy groups and one or more hydroxy groups and has a water solubility of 80% or more.

3. The ink-jet ink according to claim 1, wherein the respective contents of the first repeating unit, the second repeating unit, the third repeating unit, and the fourth repeating unit in the specific resin are, relative to 100% by mass of all the repeating units, not less than 15% by mass and not more than 55% by mass, not less than 10% by mass and not more than 40% by mass, not less than 20% by mass and not more than 35% by mass, and not less than 4% by mass and not more than 11% by mass, respectively.

4. The ink-jet ink according to claim 1, wherein the specific resin has a percentage of neutralization of not less than 20% and not more than 100%.
